(19) United States
(12) Patent Application Publication
(10) Pub. No.: US 2010/0056218 A1
(43) Pub. Date: Mar. 4, 2010

(54) Method and System for Establishing a Call in a Communication Network

(75) Inventors: Esther J. Mary, Bangalore (IN); Sandeep Bhandari, Bangalore (IN)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/514,001

(22) PCT Filed: Oct. 24, 2007
(86) PCT No.: PCT/US07/82448

§ 371 Date: May 7, 2009

(30) Foreign Application Priority Data
Nov. 21, 2006 (IN) 2506/DEL/2006

(51) Int. Cl. H04M 1/00

(52) U.S. Cl. 455/564

(57) ABSTRACT

A method and system for establishing a call in a communication network is disclosed. The method includes detecting (202) a user-activity at a User Equipment (UE) (104), prior to a special key press. The special key press triggers a request for establishing the call. The method also includes determining (206) based on the detecting whether a latest System Information Block (SIB) is available at the UE. Further, the method includes initiating (208) a Random Access Channel (RACH) session for establishing the call. The RACH session is initiated when the latest SIB is available at the UE and when the special key is pressed. The latest SIB includes parameters for the RACH session.

The present invention generally relates to the field of communication networks, and more specifically, to a method and system for establishing a call in a communication network.

### BACKGROUND OF THE INVENTION

Communication devices, for example, mobile phones, personal digital assistants (PDAs) and messaging devices are becoming increasingly popular these days. Their popularity has lead to improvements made in their functions, for example, in the process of initiating a call from a mobile phone to another communication device. Presently, when a user of the mobile phone wishes to initiate a call with another communication device, he/she first dials the telephone number of the other communication device by using, for example, the keypad of the mobile phone. After that, the user can press a voice call initiation key or a send key of the mobile phone. When the send key is pressed, a Radio Resource Control (RRC) layer of the mobile phone starts to acquire signaling information from a communication network. The signaling information can be a System Information Block (SIB) 7 that includes parameters, which the mobile phone executes to initiate the call establishment process. After the SIB 7 is acquired at the RRC, the mobile phone initiates a Random Access Channel (RACH) session with the communication network. The RACH session is performed to synchronize the functions of the mobile phone with the communication network. This, as per RRC specification 3GPP TS 25.331, result in a time delay, ranging between 80 milliseconds (ms) and 20 seconds (sec), after the send key is pressed and before the RACH session is initiated, which delays the establishment of the call. Typically, this result in a time delay, ranging between 640 milliseconds (ms) and 1.28 seconds (sec), after the send key is pressed and before the RACH session is initiated.

Therefore, a need exists for a method and system that can reduce the time taken to establish a call in a communication network.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention

FIG. 1 illustrates an exemplary communication network where various embodiments of the present invention can be practised;

FIG. 2 is a flow diagram illustrating a method for establishing a call in a communication network, in accordance with an embodiment of the present invention;

FIGS. 3 and 4 is a flow diagram illustrating a method for establishing a call in a communication network, in accordance with another embodiment of the present invention;

FIG. 5 is a flow diagram illustrating a method for initiating a communication session in a communication network, in accordance with an embodiment of the present invention;

FIGS. 6 and 7 is a flow diagram illustrating a method for initiating a communication session in a communication network, in accordance with another embodiment of the present invention; and

FIG. 8 illustrates a block diagram of an electronic communication device, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method for establishing a call in a communication network, in accordance with various embodiments of the present invention, it should be observed that the present invention resides primarily in combinations of apparatus components and method steps related to a method for establishing a call in a communication network. Accordingly, the apparatus components and method steps have been represented, where appropriate, by conventional symbols in the drawings, showing only those specific details that are pertinent for an understanding of the present invention, so as not to obscure the disclosure with details that will be readily apparent to those of ordinary skill in the art, having the benefit of the description herein.

In this document, the terms ‘comprises,’ ‘comprising,’ or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by ‘comprises . . . a’ does not, without more constraints, preclude the existence of additional identical elements in the process, method, article or apparatus that comprises the element. The term ‘another,’ as used in this document, is defined as at least a second or more. The terms ‘includes’ and/or ‘having’, as used herein, are defined as comprising.

For one embodiment, a method for establishing a call in a communication network is provided. The method includes detecting a user activity at a User Equipment (UE), prior to a special key press. The special key press triggers a request for establishing the call. Further, the method includes determining based on the detecting whether a latest System Information Block (SIB) is available at the UE. Furthermore, the method includes initiating a Random Access Channel (RACH) session to establish the call. The RACH session is initiated when the latest SIB is available at the UE and when the special key is pressed. The latest SIB includes the parameters for the RACH.

For another embodiment, a method for initiating a communication session in a communication network is provided. The method includes detecting a user-activity at a User Equipment (UE) prior to a special key press. The special key press triggers a request for establishing the communication session. Further, the method includes acquiring a latest set of connected mode System Information Block (SIB) at the UE. Furthermore, the method includes establishing the communication session when the latest set of connected mode SIB is acquired and when the special key is pressed.

For yet another embodiment, an electronic communication device is provided. The electronic communication device includes a receiver and a processor. The receiver is capable of reading a System Information Block (SIB). The receiver reads the SIB when a user-activity is detected prior to detecting a special key press on the electronic communication device. The processor is capable of initiating a Random Access Channel (RACH) session for establishing a call. The processor initiates the RACH session when the special key is pressed and when the SIB is available at the electronic communication device.

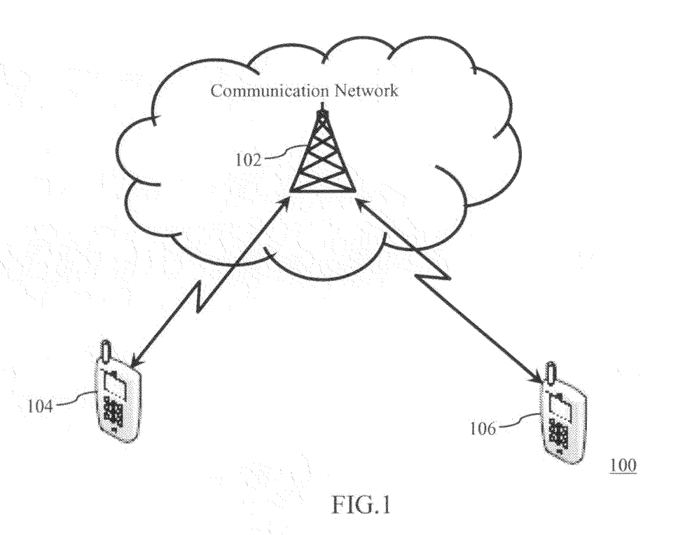

FIG. 1 illustrates an exemplary communication network 100 where various embodiments of the present invention can be practised. The communication network 100 includes some Node Bs and some User Equipments (UEs). For the purpose of this description, the communication network 100 is shown to include a Node B 102, a User Equipment (UE) 104 and a UE 106. However, it will apparent to a person ordinarily skilled in the art that the communication network 100 can include more than one Node B's and more than two UEs. Examples of the communication network 100 include, but are not limited to, a Code Division Multiple Access (CDMA) network, an Evolution-Data Optimized (EVDO) network, a Universal Mobile Telecommunications System (UMTS) network, a Global System for Mobile Communications (GSM) network, and General Packet Radio Services (GPRS). Examples of the UE 104 and the UE 106 include, but are not limited to, a mobile radio, a mobile phone, a Personal Digital Assistant (PDA), a walkie-talkie, a laptop with a wireless communication capability, and a personal computer with a wireless communication capability. The UE 104 and the UE 106 can communicate by using radio signals. Further, the UE 104 and the UE 106 can communicate with each other via the Node B 102.

To establish a communication session from the UE 104 to the UE 106, the UE 104 has to acquire a Random Access Channel (RACH) session parameters transmitted by the Node B 102 of the communication network 100. For example, in the case of the UMTS network, a Radio Resource Control (RRC) of the UE 104 has to acquire signaling messages broadcasted by the Node B 102 of the UMTS network to initiate a communication session. The RRC is a sub layer of layer 3 on the UMTS radio interface. The RRC exists in the control plane of the UMTS network and provides information transfer services between the UE 104 and the Node B 102. In an embodiment, the communication network 100 includes a Radio Network Controller (RNC). The RNC controls the operations of the Node B 102 of the UMTS network. The Node B 102 and the RNC are collectively known as UMTS Terrestrial Radio Access Network (UTRAN). When a user of the UE 104 has to establish a communication session, such as a voice call with the UE 106, the UE 104 acquires a signaling message. The signaling message contains parameters that invoke a specific RRC protocol with the UMTS network, which is transmitted by the UTRAN. For example, the signaling message the UE 104 receives can be a System Information Block (SIB). The SIB the UE 104 receives can be an SIB 7, which includes parameters for initiating the RACH session. Once the SIB 7 is acquired at the UE 104, the RACH session can be initiated by the UE 104 by using the parameters for initiating the RACH session. The RACH session is established to synchronize the UE 104 with the Node B 102 of the UMTS network.

Though the above embodiment is illustrated with respect to a Node B, however, it will be apparent to a person ordinarily skilled in the art that the present invention can also be practiced by using any other network element, for example, a base Transceiver Station (BTS) in GSM/GPRS subsystem.

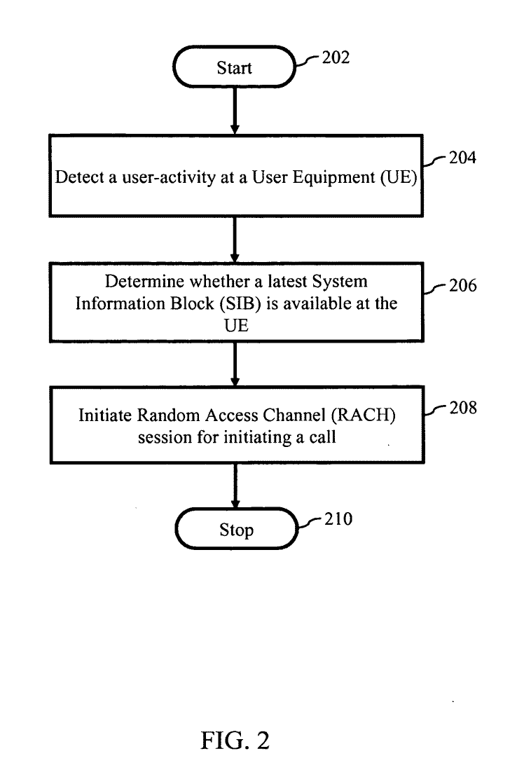

FIG. 2 is a flow diagram illustrating a method for establishing a call in the communication network, in accordance with an embodiment of the present invention. The flow diagram in FIG. 2 is described with respect to the communication network 100 in FIG. 1. However, it will apparent to a person ordinarily skilled in the art that the method can be implemented in any other suitable environment or network. The method for establishing the call in the communication network is initiated at step 202. At step 204, a user-activity is detected at the UE 104, prior to a special key press, which triggers a request for establishing the call. At step 206, it is determined whether a latest System Information Block (SIB) is available at the UE 104. The availability of the latest SIB is based on the detection of the user-activity. At step 208, a RACH session is initiated from the UE 104, to establish the call, when the latest SIB is available at the UE 104 and the special key is pressed at the UE 104. The parameters for the RACH session are extracted from the latest SIB. Thereafter, the method for establishing the call in the communication network 100 terminates at step 210.

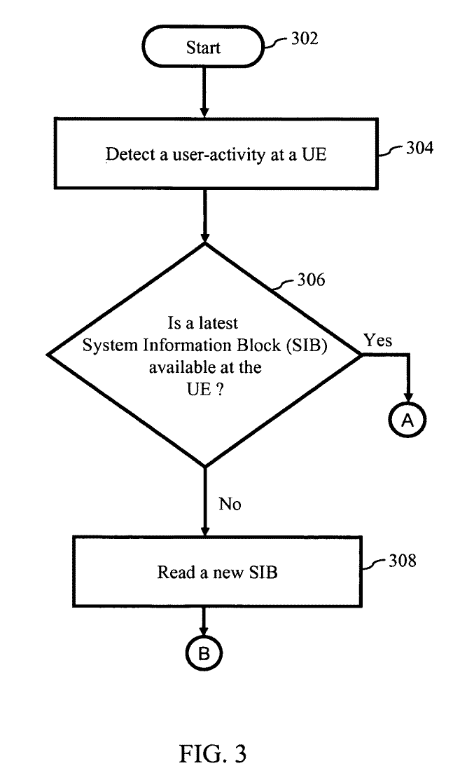

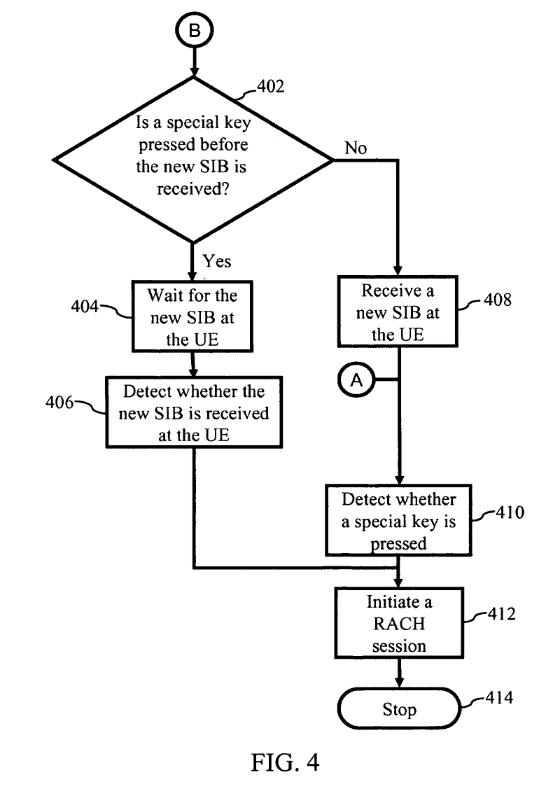

FIGS. 3 and 4 is a flow diagram illustrating a method for establishing a call in a communication network, in accordance with another embodiment of the present invention. The flow diagram in FIGS. 3 and 4 is described in conjunction with the communication network 100. However, it will be apparent to a person ordinarily skilled in the art that the method can be implemented in any other suitable environment or network. The method for establishing the call in the communication network is initiated at step 302. Examples of the call include, but are not limited to, a voice call, a data call such as an SMS, and a video call. At step 304, a user-activity is detected at the UE 104, prior to a special key press. The special key press triggers a request for establishing the call. For example, consider a scenario where a user of the UE 104 has to make a call, such as a voice call, to the UE 106. To make the call, the user has to perform an operation on the UE 104, such as dialing a telephone number of the UE 106, before pressing the special key press, such as a voice call initiation key. The operation of dialing the telephone number of the UE 106 can be detected by the UE 104 before the voice call initiation key is pressed. It will be apparent to a person ordinarily skilled in the art that the example cited above of the user-activity and the special key press is purely exemplary in nature and does not limit the scope of the invention.

Examples of the user-activity include, but are not limited to, unlocking the UE 104, opening a flip of the UE 104 when the UE 104 is a flip-open type UE, dialing one or more numeric digit keys on the UE 104, accessing a phone book on the UE 104, accessing a last dialed number on the UE 104, accessing a last received numbers menu on the UE 104, accessing a call list on the UE 104, accessing a voice dial menu on the UE 104, accessing a call back option of a Short Message Service (SMS) on the UE 104, accessing a call back option of a Multimedia Messaging Service (MMS) on the UE 104, attaching an external device at the UE 104, and accessing a call back option of a browser menu on the UE 104.

Examples of the special key include, but are not limited to, voice call initiation key, a video call initiation key, a send key, a video key, and a hash key. Since the voice call initiation key and the send key are used for initiating the voice call with the UE 106, the video call initiation key and the video key can be used to initiate a video call with the UE 106. The hash key can be applicable in a scenario where the user of the UE 104 has to check the balance amount in his/her pre-paid mobile account. To check the balance amount, the user has to press a sequence of numbers on the UE 104 provided by the communication network provider. Once the sequence of numbers are pressed on the UE 104, the user can press the hash key, which will result in the communication network transmitting the balance amount as an SMS back to the UE 104.

At step 306, it is determined whether a latest System Information Block (SIB) is available at the UE 104. The UE 104 detects the user-activity being performed by a user and then checks whether the latest SIB is available at the UE 104. For example, the instant the user performs the user-activity of dialing the telephone number of the UE 106, the RRC of the UE 104 can acquire the latest SIB, such as a latest SIB 7 transmitted by the Node B 102. Since the user requires to establish the voice call with the UE 106, the RRC of the UE 104 can acquire the latest SIB 7 that contains the parameters for initiating a RACH session. The RACH session is used to initially synchronize the UE with the communication network 100. As a result, the parameters can be used by the RRC of the UE 104 to initiate the RACH session with the Node B 102, which aids in establishing the voice call with the UE 106. At the instance of detecting the user-activity at the UE 104, the UE 104 checks whether the latest SIB 7 transmitted by the Node B 102 is acquired by the RRC of the UE 104. If it is determined at step 306 that the latest SIB is available at the UE 104, step 410 is performed.

If it is determined at step 306 that the latest SIB is unavailable at the UE 104, a new SIB is read at step 308. The new SIB is read by the UE 104 from the communication network 100. The new SIB 7 also includes the parameters for initiating the RACH session with the Node B 102. At step 402, the UE 104 detects whether the special key was pressed by the user before the new SIB was received at the UE 104, for example, while the UE 104 is reading the new SIB from the communication network 100. For instance, when the UE 104 is reading the new SIB 7, the UE 104 checks whether the user has pressed the voice call initiation key.

If it is determined at step 402 that the special key is pressed before the new SIB is received, step 404 is performed. At step 404, the UE 104 waits for the new SIB to be acquired by the RRC of the UE 104. At step 406, the UE 104 detects whether the new SIB was received at the UE 104. For example, let us assume that the user is fast in dialing the telephone number and subsequently pressing the voice call initiation key. A situation can also arise where the voice call initiation key is pressed by the user even before the new SIB7 is acquired by the RRC. In this event, the UE 104 waits till the new SIB 7 is acquired by the RRC. When the new SIB 7 is acquired by the RRC, the UE 104 detects that the new SIB 7 is available at the UE 104. Thereafter, the method flows to step 412.

If it is determined at step 402 that the special key was not pressed before the new SIB was received, step 408 is performed. At step 408, the UE 104 receives the new SIB from the Node B 102. For example, let us assume the user takes a considerable amount of time in dialing the telephone number and subsequently pressing the voice call initiation key. Thereafter, a situation can arise where the new SIB 7 is acquired by the RRC before the voice call initiation key is even pressed by the user. Thereafter, the method flows to step 410.

At step 410, the UE 104 detects whether the special key is pressed when the new SIB is received at the UE 104. For example, after the user dials the telephone number of the UE 106 and when the RRC of the UE 104 acquires the new SIB 7, thereafter the UE 104 detects that the user has pressed the voice call initiation key. At this stage, the UE 104 has the parameters to establish the call with the NODE B 102.

At step 412, when the new SIB is available at the UE 104 and when the special key is pressed by the user, the UE 104 initiates the RACH session to establish the call with the Node B 102. For example, when the RRC of the UE 104 acquires the new SIB 7 from the Node B 102 and when the voice call initiation key is pressed by the user of the UE 104, the UE 104 initiates the RACH session with the Node B 102 to establish the voice call with the UE 106. Thereafter, the method for establishing the call in the communication network terminates at step 414.

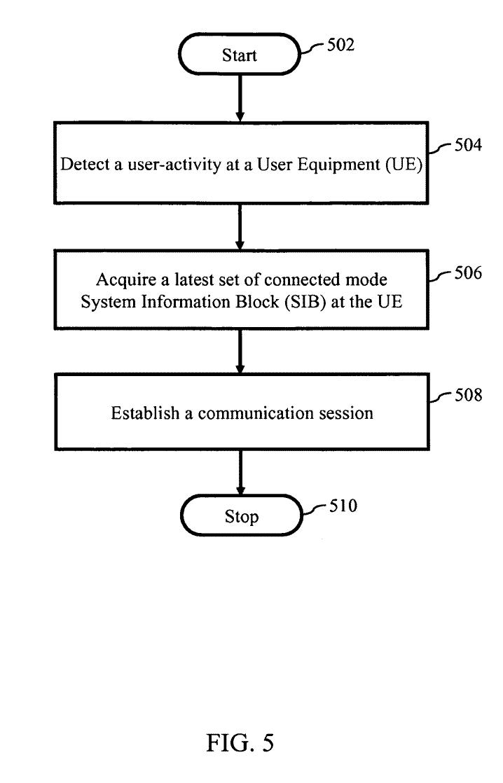

FIG. 5 is a flow diagram illustrating a method for initiating a communication session in a communication network, in accordance with an embodiment of the present invention. The flow diagram in FIG. 5 is described in conjunction with the communication network 100. However, it will apparent to a person ordinarily skilled in the art that the method can be implemented in any other suitable environment or network. The method for initiating the communication session in the communication network is initiated at step 502. At step 504, a user-activity is detected at the UE 104, prior to a special key press, which triggers a request for establishing the communication session. At step 506, the UE 104 acquires a latest set of connected mode System Information Block (SIB), for example, SIB 4, SIB 6, and SIB 12. The latest set of connected mode SIB is used in the connected mode of the UE 104. Further, the communication session is established when the latest set of connected mode SIB is acquired and when the special key is pressed at the UE 104 at step 508. Thereafter, the method for initiating the communication session in the communication network terminates at step 510.

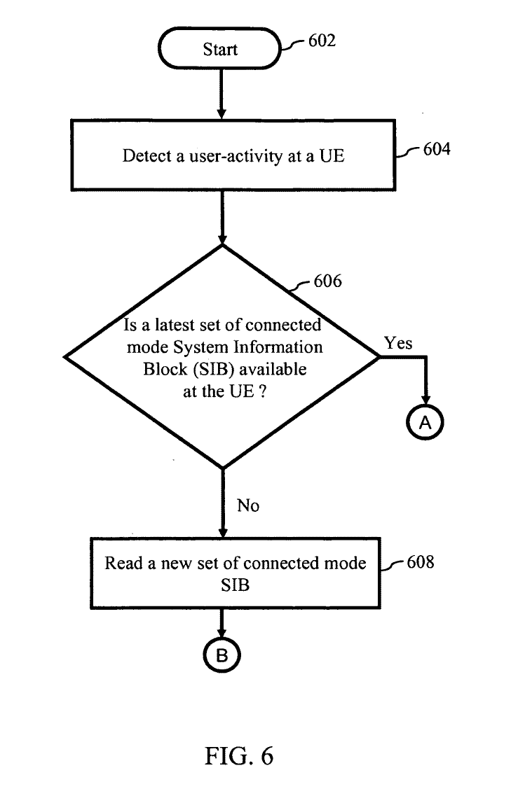

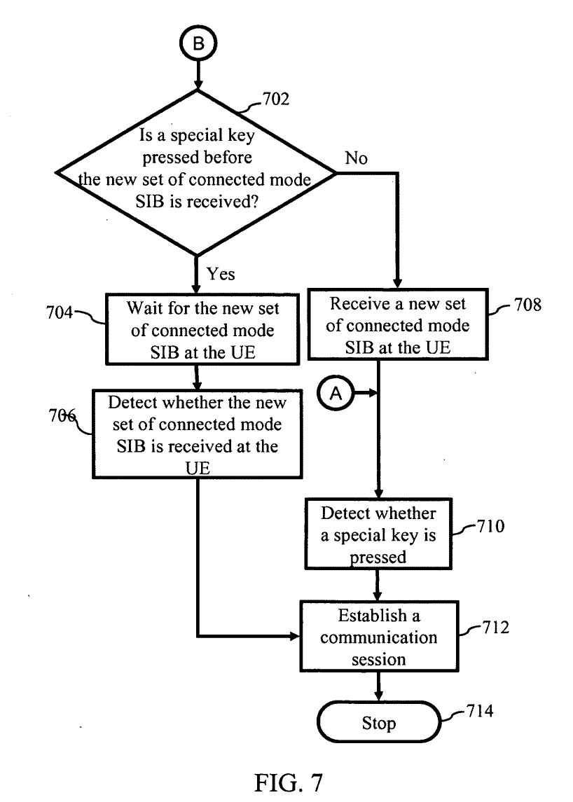

FIGS. 6 and 7 is a flow diagram illustrating a method for initiating a communication session in a communication network, in accordance with another embodiment of the present invention. The flow diagram in FIGS. 6 and 7 is described in conjunction with the communication network 100. However, it will apparent to a person ordinarily skilled in the art that the method can be implemented in any other suitable environment or network. The method for initiating a communication session in the communication network is initiated at step 602. At step 604, a user-activity is detected at the UE 104, prior to a special key press, which triggers a request for establishing the communication session. For example, consider a scenario where a user of the UE 104 has to establish a communication session, for example, a voice call session, with the UE 106. To initiate the voice call session from a server (not shown in FIG. 1) in the communication network 100, the user of the UE 104 performs an operation on the UE 104, such as opening the flip of the UE 104. The operation of opening the flip can be detected by the UE 104 before the special key, such as the send key, is pressed. It will be apparent to a person ordinarily skilled in the art that the example cited above of the user-activity and the special key press is purely exemplary in nature and do not limit the scope of the invention.

At step 606, it is determined whether a latest set of connected mode System Information Block (SIB) is available at the UE 104. The UE 104 detects the user-activity being performed by a user and then checks whether the latest set of connected mode SIB is available at the UE 104. For example, the instant the user performs the user-activity of opening the flip of the UE 104, the RRC of the UE 104 can acquire the latest set of connected mode SIB, such as an SIB 7 and an SIB 4, transmitted by the Node B 102. The SIB 7 includes the parameters for the initiation of the RACH session, to begin the communication session and achieve a connected mode. The SIB 4 includes the parameters for synchronizing the UE 104 with the communication network 100 when the user of the UE 104 moves from one tracking area to another tracking area of the communication network 100 while in the connected mode. It will be apparent to a person ordinarily skilled in the art that the example cited above of latest set of connected mode SIB is purely exemplary in nature and does not limit the scope of the invention. For instance, the latest set of connected mode SIB can be at least one SIB 4, SIB 6, SIB 7 or SIB 12. At the instance of detecting the user-activity at the UE 104, the UE 104 checks whether the latest set of connected mode SIB transmitted by the Node B 102 is acquired by the RRC of the UE 104. If it is determined at step 606 that the latest set of connected mode SIB is available at the UE 104, step 710 is performed.

If it is determined at step 606 that the latest set of connected SIB is unavailable at the UE 104, a new set of connected mode SIB is read at step 608. The new set of connected mode SIB is read by the UE 104 from the communication network 100. At step 702, the UE 104 detects whether the special key is pressed by the user before the new set of connected mode SIB is received at the UE 104, for example, while the UE 104 is reading the new set of connected mode SIB from the communication network 100. For example, when the UE 104 is reading the new set of connected mode SIB, such as the new SIB 7 and the new SIB 4, the UE 104 checks whether the user has pressed the send key.

If it is determined at step 702 that the special key is pressed before the new set of connected mode SIB was received, step 704 is performed. At step 704, the UE 104 waits for the new set of connected mode SIB to be acquired by the RRC of the UE 104. At step 706, the UE 104 detects whether the new set of connected mode SIB is received at the UE 104. For example, let us suppose that the user was quick in selecting the telephone number from the call list for the voice call session and subsequently pressing the send key. Then a situation can arise where the send key is pressed by the user even before the new set of connected mode SIB is acquired by the RRC. In this situation, the UE 104 waits till the new set of connected mode SIB is acquired by the RRC. When the new set of connected mode SIB is acquired by the RRC, the UE 104 detects that the new set of connected mode SIB is available at the UE 104. Thereafter, the method flows to step 712.

If it is determined at step 702 that the special key is not pressed before the new set of connected mode SIB is received, the method flows to step 708. At step 708, the UE 104 receives the new set of connected mode SIB from the Node B 102. For example, the user takes a considerable amount of time in selecting the telephone number from the call list for the voice call session and subsequently pressing the send key. Then a situation can arise where the new set of connected mode SIB is acquired by the RRC before the send key is even pressed by the user. Thereafter, the method flows to step 710.

At step 710, the UE 104 detects whether the special key is pressed when the new set of connected mode SIB is received at the UE 104. For example, after the user access the call list for the telephone number of the UE 106 and when the RRC of the UE 104 acquires the latest set of connected mode SIB, thereafter the UE 104 detects that the user has pressed the send key.

At step 712, the UE 104 initiates the communication session with the Node B 102 when the new set of connected mode SIB is available at the UE 104 and the special key is pressed by the user. For example, the UE 104 initiates the establishment of the voice call session with the Node B 102 when the RRC of the UE 104 acquires the new SIB 7 and the new SIB 4 from the Node B 102 and when the send key is pressed by the user of the UE 104. Thereafter, the method for initiating the communication session in the communication network terminates at step 714.

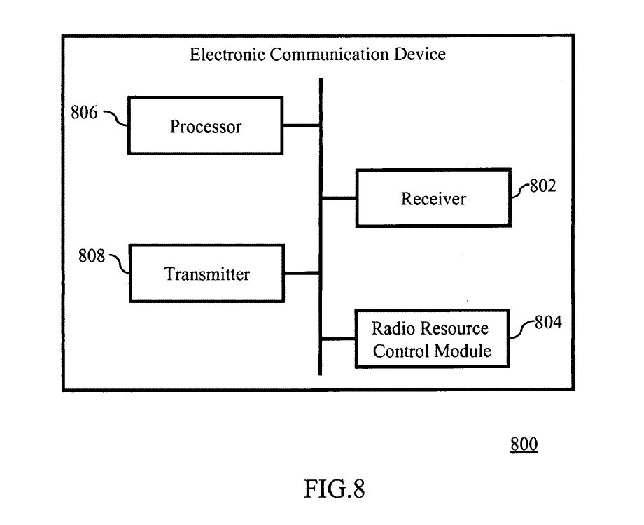

FIG. 8 illustrates a block diagram of an electronic communication device 800, in accordance with an embodiment of the present invention. The electronic communication device 800 is described with respect to the communication network 100 in FIG. 1. It will be apparent to a person ordinarily skilled in the art that the electronic communication device 800 can be the UE 104 or the UE 106. In one embodiment, the electronic communication device 800 is a mobile equipment such as a mobile phone. The electronic communication device 800 includes a receiver 802, a Radio Resource Control (RRC) module 804, and a processor 806. The receiver 802 is capable of reading a System Information Block (SIB) when the user-activity is detected at the electronic communication device 800. The receiver 802 reads the SIB prior to detecting the special key press on the electronic communication device 800. Once the receiver is capable of receiving the SIB, the RRC module 804 acquires the SIB. The processor 806 is then capable of initiating the Random Access Channel (RACH) session, using the SIB acquired by the RRC module 804, to establish the call from the electronic communication device 800. The RACH session is established when the special key is pressed and when the SIB is available at the electronic communication device 800. The processor 806 is also capable of detecting the user-activity performed by the user on the UE 104, prior to detecting the special key press on the electronic communication device 800. In an embodiment, the electronic communication device 800 includes a transmitter 808. The transmitter 808, along with the RRC module 804, is capable of transmitting the RACH session, to establish the call to the communication network 100.

Various embodiments of the present invention provide a method and system for establishing a call in a communication network. The overall time taken to establish a communication session is less, since the time taken to initiate a Random Access Channel (RACH) session with the communication network is less. For example, when the user equipment, such as a mobile phone, recognizes the user-activity, such as dialling the telephone number, the Radio Resource Control (RRC) at this instance starts to acquire a System Information Block (SIB) for the RACH session. Consequently, the SIB is available at the RRC by the time the user has dialed in the telephone number. Thereafter, the RRC can initiate the RACH session as soon as the user has pressed a send key. Also, the RRC does not have to read the SIB 7 in idle state, since the RRC reads the SIB 7 only when the user-activity is detected, thereby saving battery power. Similarly, the RRC reads the connected mode SIBs only when the user-activity is detected, other than the cases when a periodic SIB updating is required, thereby saving battery power.

It will be appreciated that the method and system for establishing a call in a communication network, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of the method and system for establishing a call in a communication network. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one of ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one of ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for establishing a call in a communication network, the method comprising:
detecting a user-activity at a User Equipment (UE) prior to a special key press, wherein the special key press triggers a request for establishing the call;
determining based on the detecting whether a latest System Information Block (SIB) is available at the UE; and
initiating a Random Access Channel (RACH) session for establishing the call when the latest SIB is available at the UE and when the special key is pressed, wherein the latest SIB comprises parameters for the RACH session.

2. The method as recited in claim 1, wherein the user-activity is selected form a group comprising unlocking the UE, opening a flip of the UE when the UE is a flip-open type UE, dialing one or more numeric digit keys on the UE, accessing a phone book on the UE, accessing a last dialed number on the UE, accessing a last received numbers menu, accessing a call list, accessing a voice dial menu, accessing a call back option of a Short Message Service (SMS), accessing a call back option of a Multimedia Messaging Service (MMS), attaching an external device at the UE, and accessing a call back option of a browser menu.

3. The method as recited in claim 1, wherein the special key is at least one of a voice call initiation key, a video call initiation key, a send key, a video, and a hash key.

4. The method as recited in claim 1, wherein the call is at least one of a voice call, a data call, and a video call.

5. The method as recited in claim 1, wherein the latest SIB is an SIB 7.

6. An electronic communication device comprising
a receiver capable of reading a System Information Block (SIB) when a user-activity is detected prior to detecting a special key press on the electronic communication device; and
a processor capable of initiating a Random Access Channel (RACH) session for establishing a call when the special key is pressed and when the SIB is available at the electronic communication device.

7. The electronic communication device as recited in claim 6, wherein the processor is further capable of detecting the user-activity prior to detecting the special key press on the electronic communication device.

8. The electronic communication device as recited in claim 6 further comprising a transmitter capable of transmitting the RACH session for establishing the call to a communication network.

9. The electronic communication device as recited in claim 6 further comprising a Radio Resource Control (RRC) capable of transmitting the RACH session for establishing the call to a communication network.

10. The electronic communication device as recited in claim 6, wherein the electronic communication device is a mobile equipment.
